(19) United States
(12) Patent Application Publication
(10) Pub. No.: US 2006/0098101 A1
(43) Pub. Date: May 11, 2006

(54) Equipment for audio/video acquisition and transmission which can be thrown into predetermined places

(76) Inventor: Cino Robin Castelli, Lugano (CH)

Correspondence Address: YOUNG & THOMPSON, 745 SOUTH 23RD STREET, 2ND FLOOR, ARLINGTON, VA, 22202, US

(21) Appl. No.: 10/539,078

(22) PCT Filed: Oct. 12, 2004
(86) PCT No.: PCT/IB04/03330

§ 371 Date: Jun. 15, 2005

(30) Foreign Application Priority Data
Oct. 15, 2003 (CH) 01756/03

(51) Int. Cl. H04N 5/232

(52) U.S. Cl. 348/211.99

(57) ABSTRACT

An equipment for acquiring and transmitting images and/or sounds, which is fitted inside a protective housing consisting of a base plate on which the said equipment is fixed in such a way that it can rotate. A cover hinged on the edge of the base plate, which, when it is made to rotate with respect to the base plate and is laid on top of and parallel to the latter, contains the equipment inside it, the cover and the base plate being connected together by connecting elements which can be released by remote control, and elastic elements being interposed between the base plate and the cover to cause a relative rotation between the cover and the base plate with an amplitude of at least 90 degrees, the weight of the equipment combined with the base plate being greater than that of the cover.

The present invention relates not only to the field of equipment for acquiring and transmitting images and/or sounds, but also to the field of strategic equipment which can be used for military or police operations and the like.

This is because the invention relates to equipment of the type described above, which is known in respect of its components, but which is provided with additional parts fitted in such a way that it can be thrown (within a limited operating range) and which make the equipment capable, as described below, of orientating itself in the most suitable position for the performance of its functions, regardless of the position which it occupies on reaching the ground at the end of the trajectory along which it is thrown.

The equipment according to the invention, which to the knowledge of its inventor is novel, is enclosed in a protective housing consisting of a base plate, on which it is fixed, and a cover which closes like the shell of a mollusc on to the said base plate, on the edge of which the cover is hinged, thus protecting the said equipment from impact and enabling it to be thrown as described above.

When connecting means acting between the base plate and the cover are released by remote control or by other methods, the cover opens under the pressure exerted by suitable elastic means, and rotates through at least 90°, thus permitting the free operation of a video camera and/or part of the equipment designed for sound recording and transmission.

The equipment, which is fixed rotatably to the said base plate, is rotated continuously or intermittently by a battery-powered miniature electric motor, and can survey the whole field of the surrounding environment.

The weight of the said cover is considerably lower than that of the base plate and equipment combined, and consequently, when the cover rotates as described above, the equipment, regardless of its initial position on the ground where it has fallen, always eventually reaches the most appropriate position, in other words that in which the base plate, which is substantially flat externally, rests parallel to the ground.

The equipment can advantageously be provided with built-in means of illumination (spotlights or the like) which rotate together with the equipment to provide a clear view of the surrounding environment.

When the equipment is to be thrown into environments in which liquid substances are present, all the components can be made, according to known methods and principles, in impermeable versions and with arrangements to ensure sealing at points where this is required.

The use of the equipment according to the invention greatly reduces the risks associated with military or police operations in cases in which it is necessary to enter closed environments or those whose details cannot be determined because of natural or artificial obstacles, absence of illumination, etc.

The present invention therefore proposes equipment for acquiring and transmitting images and/or sound as described in the attached claim 1.

A more detailed description will now be given of a preferred embodiment of the equipment according to the invention, with additional reference to the attached drawings, in which:

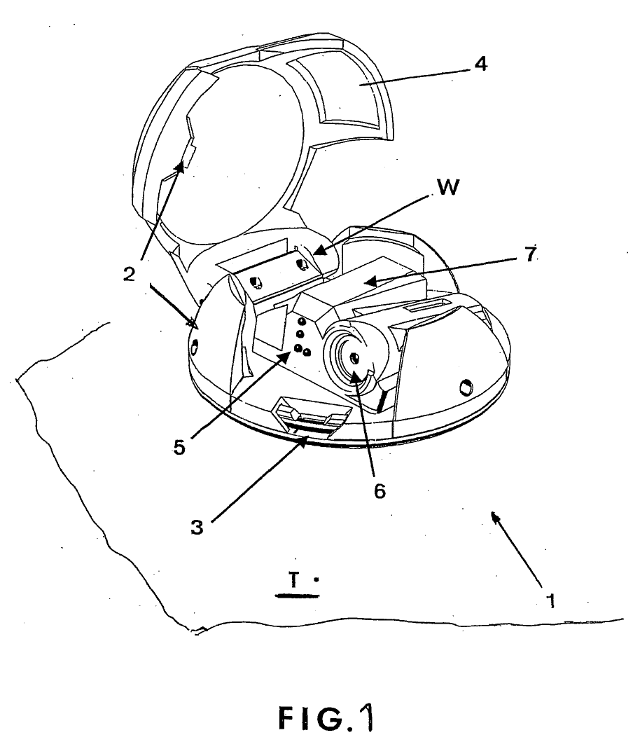

FIG. 1 is a perspective view of the said example of embodiment of equipment according to the invention;

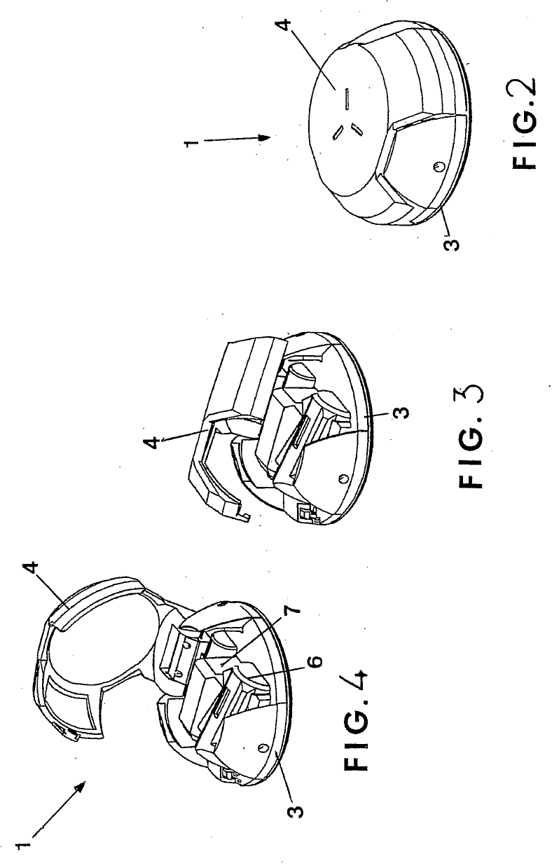

FIGS. 2 to 4 are perspective views of a sequence of positions leading to the opening of the cover of the equipment of FIG. 1, starting with the position in which the cover is closed and the base plate of the equipment is resting on the ground;

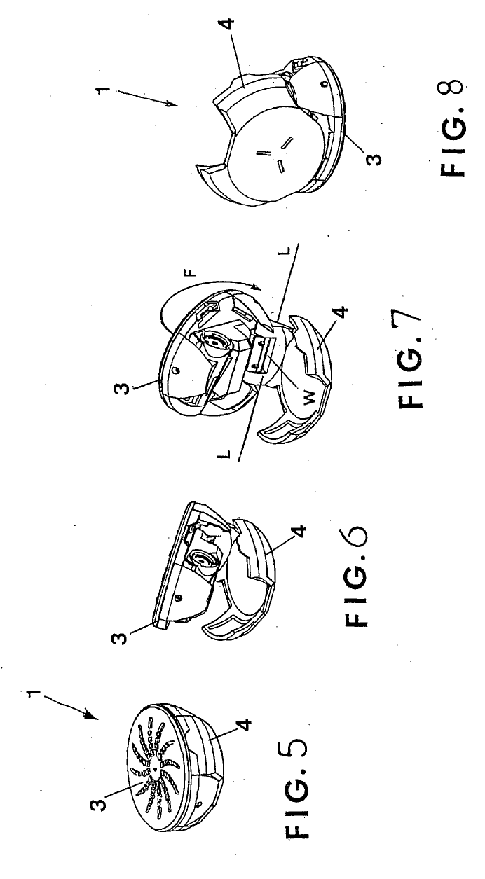

FIGS. 5 to 8 are perspective views of a sequence of positions leading to the opening of the cover of the equipment of FIG. 1, starting with the position in which the cover is closed and the cover of the equipment is resting on the ground.

With reference to FIG. 1, this shows how the equipment 1 according to the invention comprises a small video camera 6 and a microphone 7 with a radio transmitter of a known type, fixed on a circular base plate 3 in such a way that it can rotate with respect to the latter. The said base plate 3 is substantially flat on its outer surface, which comes into contact with the ground T when the equipment 1 described above is orientated in the optimal position for performing its functions.

A cover 4 is hinged in an area W to the edge of the base plate 3, and is shaped in such a way that, when it is made to rotate with respect to the base plate 3 until it lies on top of it and parallel to it, it contains the equipment 1 inside it. (See FIG. 2).

The cover is kept in this position by connecting means of a known type, which are not shown in the drawing but can easily be envisaged by a person skilled in the art, such as a clip which can be released electromagnetically, or similar elements.

The said means can also be released by rotating the equipment 1 with respect to the base plate 3, this rotation also being remotely controllable.

In the area W in which the cover 4 is hinged on the edge of the base plate 3 there is fitted an elastic element (not shown), for example a strip spring or helical spring, which has a predetermined resistance to the closing of the cover 4 and which, when the said connecting means between the plate 3 and the cover 4 are released, causes the cover 4 to rotate backwards through an angle equal to or preferably greater than 90 degrees.

The equipment 1 is preferably provided with means of illumination 5 for illuminating the surrounding environment in cases in which illumination is insufficient or absent.

When the cover 4 has been closed, by overcoming the resistance of the elastic means described above, the equipment 1, contained and protected by the housing 2 (preferably made from an impact-resistant material), can be thrown into the environment that is to be surveyed.

If the equipment 1 falls on to the ground T in the position shown in FIG. 2, it is simply necessary to release, as stated, the connecting means between the base plate and the cover 3, and the latter will rotate through 90 or more degrees (FIGS. 3 and 4) and open, leaving a free field of vision for the video camera 6 which, also being remotely controllable, sends the images of the surrounding environment, lit by the means of illumination 5 described above, and the microphone 7 records the sounds produced in the said environment. Both the sounds and the images are sent to a receiver unit, which may simply consist of a television receiver suitable for the purpose, and the events occurring in the environment in which the equipment 1 has been thrown can then be seen and heard.

The equipment 1 is preferably provided with a battery-powered miniature electric motor which, when activated by known systems, rotates the equipment 1 continuously about a vertical axis, so that the surrounding environment can be scanned with a 360 degree angle of view. The speed of rotation of the said miniature motor as suggested by the inventor is approximately 6 revolutions per minute.

The equipment 1 can thus perform its functions.

If the housing 2 containing the equipment 1 remains in the inverted position after it has been thrown, with its cover 4 resting on the ground as shown in FIG. 5, the opening of the cover 4 and its rotation through 90 or more degrees about its hinging area W, caused by the previously described elastic means, bring the base plate 3, and the equipment 1 mounted on it, into a position which is at least vertical (FIGS. 6 and 7), and, since the combination of the equipment 1 and the base plate 3 has a weight considerably greater than that of the cover 4, a moment is generated with respect to the line L-L tangent to the cover 4 in the proximity of the area in which it is hinged on the base plate 3, thus causing the housing 2 to turn over (arrow F) and reach the equilibrium position in which the base plate 3 again rests on the ground T (FIG. 8). The equipment 1 can then be put into operation as shown above.

To summarize, the equipment 1 always automatically reaches its most functional position, regardless of the position in which it lands on the ground T after it has been thrown.

To facilitate the movement of the components of the housing 2 in the overturning manoeuvres and to reduce the effect of any impact, the inventor suggests that both the base plate 3 and the cover 4 be made with rounded profiles without corners, and preferably circular as in the example illustrated up to this point.

Clearly, the various components such as the video camera 6, the microphone 7, the means of illumination 5, etc., can be positioned in a different way from that shown in the drawings. As regards the nature and procedures of remote control of the equipment 1, it is possible to use methods and principles which are known in this field of application.

1. Equipment (1) for acquiring and transmitting images and/or sounds, characterized in that it is fitted inside a protective housing (2) consisting of a base plate (3) with a substantially flat external surface (5), on which the said equipment (1) is fixed in such a way that it can rotate, and a cover (4) hinged on the edge of the said base plate (3) and shaped in such a way that, when it is made to rotate with respect to the base plate (3) and is laid on top of and parallel to the latter (3), it contains the equipment (1) inside it, the cover (4) and the base plate (3) being connected together, when the cover (4) is closed, by connecting means which can be released by remote control, and elastic means being interposed between the base plate (3) and the cover (4) to cause a relative rotation between the cover (4) and the base plate (3) with an amplitude equal to or greater than 90 degrees, the weight of the combination of the equipment (1) and the base plate (3) on which it is fixed being greater than that of the cover (4).

2. Equipment according to claim 1, provided with means, also remotely controllable, for rotating it with respect to the base plate (3) on which it is fixed.

3. Equipment according to claim 2, in which the means for rotating the base plate are battery-powered electric motors with a speed of rotation of approximately 6 revolutions per minute.

4. Equipment according to claim 1, provided with means of illumination (5) orientated towards the exterior.

5. Equipment according to claim 1, characterized in that it consists of elements capable of operating even when they are in contact with a liquid.

6. Equipment according to claim 1, in which the cover (4) and the base plate (3) are made from impact-resistant material.
